(19) United States
(12) Patent Application Publication
(10) Pub. No.: US 2005/0048955 A1
(43) Pub. Date: Mar. 3, 2005

(54) Method and apparatus for initiating a call from a communication device

(76) Inventor: Steffen Ring, Charlottenlund (DK)

Correspondence Address: MARSHALL, GERSTEIN & BORUN (MOTOROLA), 233 SOUTH WACKER DRIVE, SUITE 6300, CHICAGO, IL, 60606-6402, US

(21) Appl. No.: 10/654,049

(22) Filed: Sep. 3, 2003

(51) Int. Cl. H04M 3/42

(52) U.S. Cl. 455/414.1; 455/414.4; 455/90.1

(57) ABSTRACT

A user of a communication device (100) may initiate a communication, i.e., a telephone call, a text message, a page, an alert and the like, via a macro manipulation of the device (100), silently and in a clandestine manner without having to identify and activate a particularly button or sequence of buttons on the communication device. The communication device (100) may include housing (102) into which is disposed a sensor (120) that is actuated by the user. An input from the sensor (120) is associated with a particular communication context. Responsive to the input from the sensor (120), the communication device (100) initiates the communication according to the define context.

### TECHNICAL FIELD

This patent relates to communication devices such as telephones, cellular telephones, pagers, e-mail appliances, personal digital assistants (PDA) and the like, and more particularly, this patent relates to a method and apparatus for initiating a communication from such a device.

### BACKGROUND

Communication devices and particularly wireless communication devices provide a great deal of convenience and flexibility to the user of the device. These devices also offer the user a measure of safety and security, in that they allow the user to contact help or appropriate authorities in the event of an emergency situation. Many communication devices also allow the user to retain within a memory of the communication device a list of contacts and corresponding contact information. For example, the list may contain the names of family, friends, business contacts, etc. and corresponding telephone numbers, email addresses or other information useable to establish a communication. Some communication devices also allow storage of emergency numbers, and some communication devices allow the user to program a particular user input, for example a key or sequence of keys on the numeric keypad of the telephone, to initiate a call. This feature may be referred to speed dialing or one touch calling.

Communication devices have become smaller with the advance of communication technology. For example, cellular telephone handsets have in recent years become increasingly smaller with a corresponding reduction in the size of the key pad buttons. Some cellular telephone handsets no longer include a numeric key pad and instead provide a liquid crystal display (LCD) touch screen interface for accepting user input. These traditional user input devices do not offer the user the opportunity to place a call from the handset silently and even in total darkness without looking at it, speaking to it or identifying and pressing one particular signal key.

### BRIEF DESCRIPTION OF THE DRAWINGS

FIG. 1 is a perspective view of a cellular telephone in accordance with a described embodiment.

FIG. 2 is a block diagram of a communication device in accordance with a described embodiment.

FIG. 3 is a timing diagram illustrating a process for initiating a call in accordance with a described embodiment.

FIG. 4 is a flow chart illustrating a method for initiating a call in accordance with a described embodiment.

### DETAILED DESCRIPTION

A user of a communication device may initiate a communication, i.e., a telephone call, a text message, a page, an alert and the like, silently, via a macro-manipulation of the communication device and without having to identify a particularly button or sequence of buttons on the communication device. The communication device may include housing into which is disposed a sensor that detects the macro-manipulation of the communication device by the user. An output from the sensor is associated with a particular communication context, e.g., a particularly telephone number to which a call is to be completed, a communication device to which a text message is to be sent and the contents of the text message, an email address to which an email is to be sent, a pager to which either a page number, text or numeric message is to be sent, and the like. Responsive to the output from the sensor, the communication device initiates the communication according to the define context. Thus, a user of the communication device may initiate a communication in total darkness, without removing the communication device from a purse or pocket, and without having to identify a particular key or keys on the communication device.

To limit the possibility of unintended communication originations or to provide security for the predetermined communication, a defined sequence of sensor outputs and responses may be provided within the communication unit. For example, to a first sensor input the communication unit may respond with a particular response or alert. The response may be a short vibratory stimulus or other haptic alert to preserve the clandestine manner in which the communication is to be initiated. The user, responsive to the alert may be required to take additional action, for example, to trigger the sensor to provide a second sensor output to which the communication device may be responsive to initiate the communication. As will be appreciated, a variety of sequences may be envisioned. Predefined sequences may be associated with one or more different communications.

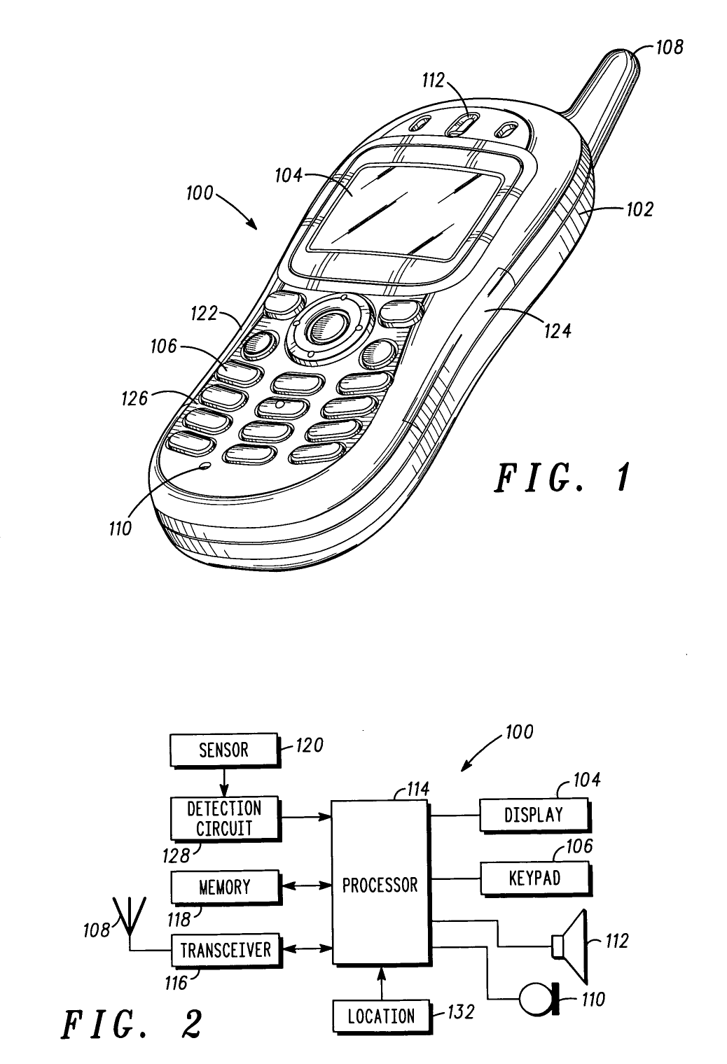

Referring to FIG. 1, a communication device 100, such as the cellular telephone depicted, includes a housing 102, a display 104, a keypad 106, an antenna 108, a microphone 110 and a speaker 112. In this manner, the cellular telephone is conventional. The communication device need not be a cellular telephone. Instead, the communication device may be a portable telephone coupled to a wireline telephone network, a wireline telephone, a pager, a personal digital assistant (PDA), a portable computer, such as a laptop or palm-type computer, or any communication device capable of initiating a communication. The term communication device, and the examples given herein, is used broadly and generically to refer to any communication device that may be adapted to operate as described herein.

With continued reference to FIG. 1 and reference also to FIG. 2, the communication unit 100 includes a processor 114 secured within the housing 102. The processor 114 is coupled to the display 104, the keypad 106, the microphone 110 and the speaker 112 via suitable, conventional circuitry. The processor 104 is also coupled to a transceiver 116 that is coupled to the antenna 108 and to a memory 118. The memory 118 may contain a control program for directing operation of the processor 104 in a manner consistent with the operation of the communication device 100 described herein. Alternatively, a suitable control program or instructions may be retained within a memory disposed within the processor 114, the processor 114 may be specifically configured to operate as described herein, or combinations of such techniques may be employed.

The communication device 100 further includes a sensor 120 that is coupled to the processor 114. The sensor 120 may be coupled via suitable detection circuitry 128. The sensor 120, responsive to macro-manipulation of the communication device 100 by the user, provides an output that is detected by the detection circuitry 128 to provide a signal to the processor indicative of the user's macro-manipulation of the communication device 100. It will be appreciated that the sensor 120 may provide the output signal directly to the processor 114 without using a detection circuit.

The sensor 120 may be capacitive, resistive or any suitable sensor technology. For example, the sensor 120 may be one or more strain gages molded into the housing 102. The strain gages may be simple wire strain gages arranged in a bridge circuit configuration; such that pressure applied to the housing 102 may cause an unbalancing of the bridge circuit that may be detected by the detection circuit 128 to produce the output signal communicated to the processor 114. The strain gages may be piezo-resistive devices that provide a direct indication to the processor responsive to pressure being applied to the housing 102.

Referring still to FIG. 1, in one particular embodiment, the sensor 120 may be formed as a pair of carbon fiber strips 122 and 124 disposed on an outer surface 126 or embedded within the surface 126 of the housing 102, such that they may be invisible. The strips 122 and 124 may be coupled via detection circuit 128, which may in this embodiment be a current variation detection circuit, to the processor 114. The detection circuit 128 may also provide pulse shaping and other signal conditioning as is well known in the art. Moisture and salt on the user's hand, when applied across the strips 122 and 124 will short circuit the strips 122 and 124 allowing a small amount of electric current to flow form a source (not depicted but which may be supplied by a battery or other power source within the communication device 100) through the strips 122 and 124 via the user's hand. When the housing 102, and the strips 122 and 124 are squeezed in the user's hand, resistance between the user's hand and the strips 122 and 124 drops sharply permitting an increase amount of current to flow and producing a current pulse in the detection circuit 128. Responsive to the current pulse, the detection circuit 128 provides the sensor output signal to the processor 114.

The processor 114, in response to the current pulse detected by the detection circuit 128, may initiate a communication in accordance with a predefined communication parameter stored within the memory 118. The communication may be of any type. For example, the communication may be a call initiated to a particular telephone number stored within the memory 118. The telephone number may be an emergency service such as the police. In an emergency situation, where the user may not be able to speak and/or it may not be possible to remove the communication device from a pocket or purse, the user may easily and silently initiate a call for help simply by macro-manipulating, e.g., squeezing the housing 102, the communication device 100.

The memory 118 may further contain a prerecorded message that may be played, as it may not be possible for the user to speak or the situation may be such that the user can not safely speak. The communication device 100 may further include a global positioning system (GPS) and/or or other suitable location determination circuitry, generally a location detector module 132, which may provide in addition to any prerecorded message the user's position so that emergency services may respond.

The communication need not be a telephone call to a predefined number. The communication may be a text message, a two-way communication alert, an email, a page or other such text, data, recorded message or recorded voice communication. The short text message, email, page information (message and/or number) or such communication, may be stored in the memory 118 and used to form the message upon receipt by the processor 114 of the output signal from the sensor 120. The short text message, email, page or other communication may be augmented with location information as described above.

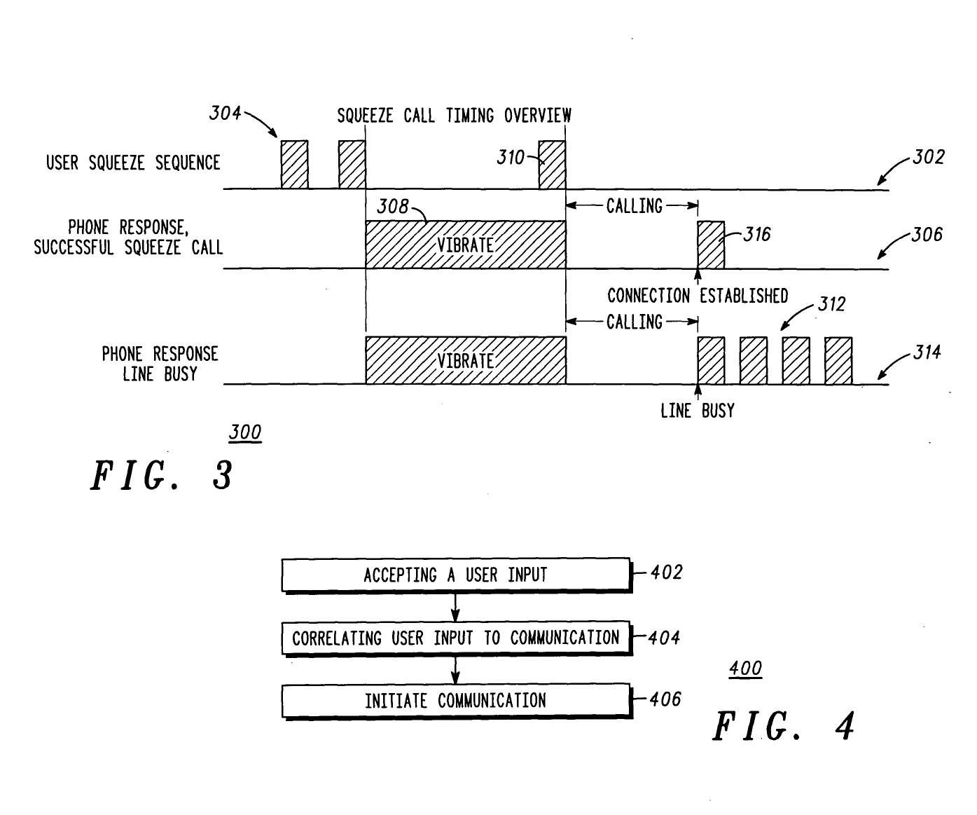

To avoid the possibility of inadvertently triggering the communication, such as by simply grasping the housing too firmly or by other circumstances that may cause the sensor 120 to provide an output signal to the processor 114, a protocol for initiating the communication may be implemented. The timing diagrams shown in FIG. 3 illustrate one such protocol 300. To initiate the communication, as shown along line 302, the user is first required to twice quickly squeeze the housing 102 of the communication unit 100 shown by the pulses 304. This action, similar to the “double click” action taken with a mouse input device on a computer, causes the communication unit 100 to provide the response indicated on line 306, which is to provide a haptic response 308, such as a vibratory alert. The user, during the period of the haptic response 308, again squeezes the housing 102 to generate a signal from the sensor 120, 310. The communication unit 100 responsive to the sensor input 310 ends the haptic alert, and initiates the communication. If it is not possible to complete the communication, e.g., the line is busy; the communication unit 100 may provide an additional haptic alert 312, such as a series of burst vibrations, as indicated on line 314. When the communication is completed, e.g., the call is completed and/or the text message, email or page is sent, the communication unit 100 provides still an additional haptic alert 316, such as a short pulse vibration. If the communication is a call, the user may then participate on the call in a normal fashion. If the communication does not require further communication, the protocol ends.

A method 400 for initiating a communication is described in connection with the flowchart illustrated in FIG. 4. A communication device, such as the communication device 100, accepts a user input corresponding to a macro manipulation of the communication device, block 402. The communication device the correlates the user input with a predetermined communication, block 404 to determine the particular communication to be initiated corresponding to the user input. The communication device then initiates the communication, block 406.

As will be appreciated, several different types of communications may be initiated in a manner consistent with the protocol 300. For example, the user may initiate the concealed communication feature by initiating the double squeeze action 304, to which the communication unit 100 responds with the sustained haptic alert 306. The user may then provide one, two, three or more squeezes, quickly in sequence, to indicate that a first, a second or a third communication, and so on, is to be initiated. The particular communication corresponding with the number of squeezes, one, two or three, for example, are retained in the memory 118. The communication unit 100 may respond by providing a corresponding number of vibratory pulses so that the user is informed that the correct communication has been selected. The user may then provide an additional input, i.e., an additional squeeze, to acknowledge the selected communication, and the communication unit 100 completes the selected communication.

The protocol 300 may consist of a predetermined sequence of user macro-manipulations of the communication device 100 to produce sensor output signals and responses by the communication device 100. The sequence may thus provide a level of security such that the communication may be initiated only by a user knowing the correct sequence of macro-manipulations.

As described, a communication unit, such as communication decice 100, provides an ability to silently and covertly initiate a selected communication. A user may initiate a selected communication without having to identify, select or manipulate pushbuttons or other input devices on the communication unit, which are constantly shrinking in size. That is, the user may initiate the communication with a macro-manipulation of the communication device. Additionally, in an emergency situation, the user may summon help without revealing that such a request for help has been initiated, as the microphone of the communication device will be active and capture and transmit all audio activity taking place arounde the calling party.

The invention has been described in terms of several preferred embodiments and examples. One of skill in the art will appreciate that the invention may be otherwise embodied without departing from its fair scope, which is defined only by the subjoined claims.

1. A communication device comprising:
a housing;
a sensor disposed on a surface of the housing and responsive to a user macro-manipulation of the communication device to provide a sensor output;
a processor disposed within the housing, the processor operable responsive to receiving the sensor output to initiate a predefined communication associated with receipt of the sensor output.

2. The communication device of claim 1, wherein the macro-manipulation comprises squeezing by the user of the housing.

3. The communication device of claim 1, wherein the sensor comprises a sensor selected from the group of sensors comprising: a pressure sensor, a resistive sensor and a capacitive sensor.

4. The communication device of claim 1, wherein the sensor comprises a pair of spaced apart carbon fiber strips disposed on the housing, and a current detection circuit coupled to the carbon fiber strips and to the processor.

5. The communication device of claim 1, wherein the communication comprises a communication selected from the group of communications comprising: a voice call, a recorded audio message, a text message, an email message and a page message.

6. The communication device of claim 1, wherein the processor is operable to implement a protocol comprising a user input and a corresponding communication device response for initiating the communication

7. The communication device, the communication device comprising location determination circuitry, the processor being operable to include in the communication information relating to the current location of the communication device.

8. The communication device of claim 1, wherein the processor is operable to select a communication from a plurality of predefined communications to provide a selected communication and to initiate the selected communication.

9. A method of initiating a communication from a communication device, the method comprising:
accepting a user input corresponding to a macro manipulation of the communication device;
correlating the user input with a predetermined communication; and
initiating the communication.

10. The method of claim 9, wherein the macro manipulation of the communication device comprises a predetermined sequence of macro manipulations.

11. The method of claim 9, comprising providing a response to the user input and accepting an acknowledgement from the user to the response.

12. The method of claim 11, wherein the acknowledgement comprises a further macro manipulation of the communication device.

13. The method of claim 9, wherein the macro manipulation of the communication device comprises squeezing the housing of the device.

14. The method of claim 9, wherein the step of initiating the communication comprises selecting a communication from a plurality of communications to provide a selected communication corresponding to the user input, and initiating the selected communication.

15. The method of claim 9, wherein the step of initiating the communication comprises initiating a communication from the group of communications comprising: a voice call, a recorded audio message, a text message, an email message and a page message.

16. The method of claim 9, further comprising determining a location of the communication device and wherein the step of initiating the communication comprises including in the communication communication device location information.

17. An apparatus comprising:
means for receiving a user input corresponding to a macro manipulation of a communication device; and
means for initiating a communication from the communication device corresponding to the user input.

18. The apparatus of claim 17, wherein the means for receiving a user input comprises a sensor disposed within a housing of the communication device, the sensor being responsive to a user squeezing the housing of the communication device.

19. The apparatus of claim 17, wherein the communication comprises a communication from the group of communications comprising: a voice call, a recorded audio message, a text message, an email message and a page message.

20. The apparatus of claim 17, wherein the means for initiating the communication comprises means for preventing initiation of an unintended communication.
